(19) United States
(12) Patent Application Publication
(10) Pub. No.: US 2004/0192275 A1
(43) Pub. Date: Sep. 30, 2004

(54) Telecommunication method based on location information of communication unit and apparatus thereof

(76) Inventor: Myun Sik Kim, Anyang-city (KR)

Correspondence Address: Ronald R Santucci, Frommer Lawrence & Haug, 745 Fifth Avenue, New York, NY, 10151, US

(21) Appl. No.: 10/484,914

(22) PCT Filed: Jul. 27, 2002
(86) PCT No.: PCT/KR02/01408

(30) Foreign Application Priority Data
Jul. 27, 2001 (KR) 52001/45481

(51) Int. Cl. H04M 3/00

(52) U.S. Cl. 455/418; 455/403

(57) ABSTRACT

A communication method and apparatus using location information of a communication unit are provided. The communication method includes (a) receiving and storing information on other communication terminals within a coverage area, (b) receiving data from a transmission terminal, (c) removing the received data when a communication terminal receiving the data is not a destination of the received data, and (d) when the communication terminal receiving the data is the destination, but not a final destination, transmitting the data to another communication terminal nearest to the final destination within a coverage area of the communication terminal receiving the data. Accordingly, data can be transmitted from one communication terminal to another communication terminal, out of the coverage area of the one communication terminal, using communication terminals as relays, so it is not necessary to establish an extra base station, thereby providing an economical and convenient communication method and apparatus.

### TECHNICAL FIELD

The present invention relates to a communication method and apparatus using location information of a communication unit.

### BACKGROUND ART

Internet allows computers all over the world to communicate with one another based on a TCP/IP. Over the Internet, data is exchanged through networks in the form of packets using network addresses, i.e., IP addresses, and bridges or routers. In the case of a LAN, data are exchanged within the LAN using sub IP addresses, and are exchanged over the Internet through hosts or servers having Internet IP addresses. In the meantime, for data transmission among network apparatuses, MAC addresses are used. MAC addresses, referred to as physical addresses, are unique numbers allocated to individual ports, such as LAN cards, of each network apparatus in order to identify destinations when data is transmitted.

Recently, as wireless LANs have been widely spread, wireless terminals are connected to an existing wired LAN, such as Ethernet, through a wired-to-wireless connection device, i.e., an access point (AP). There are various types of wireless communication. In a wide area, a commercial network for cellular phones or truncated radio system (TRS) using a frequency band exclusively allocated by the authorities can be used. In a narrow area, an Industrial Scientific and Medical (ISM) frequency band, which does not require any permission, is used. An ISM band signal, which can be used by anyone without requiring permission, has a low output power, and thus can be used only in a narrow local area.

FIG. 1 shows conventional data communication paths. In FIG. 1, reference characters D1 through D20 denote communication terminals. Reference characters C1 through C4 denote primary communication relays functioning as routers. Reference characters B1 and B2 denote secondary communication relays. Reference character A1 denotes a tertiary communication relay. When data is transmitted from the communication terminal D1 to the communication terminal D12, the data is transmitted through a communication path \mathring{1}→\mathring{2}→\mathring{3}→\mathring{4}→\mathring{5}→\mathring{6}.

When many terminals are used as in a peer to peer (P2P) data communication system or metering system within a narrow area, as shown in FIG. 1, wireless communication using an ISM band having a low output power can be used. However, since a communication distance is short, it is required to install relay base stations in order to perform long-distance communication. In the mean time, when a commercial network for, e.g., cellular phones is used, the price is expensive, and IP addresses must be uniquely allocated to individual terminals.

### DISCLOSURE OF THE INVENTION

To solve the above-described problems, it is an object of the invention to provide a communication method and apparatus using location information of a communication unit.

To achieve the object of the present invention, there is provided a communication method including (a) receiving and storing information on communication terminals of the same model within a coverage area; (b) receiving data from a transmission terminal; (c) determining whether a communication terminal receiving the data is a destination of the received data based on the received data and removing the received data when the communication terminal is not the destination of the received data; and (d) determining whether the communication terminal is a final destination of the received data based on the received data when the communication terminal is the destination and transmitting the data to another communication terminal within a coverage area of the communication terminal that has received the data when the communication terminal is not the final destination. In step (b), the received data includes latitude and longitude information indicating a position of the communication terminal receiving the data, and latitude and longitude information indicating a position of a communication terminal corresponding to the final destination. In step (d), if the communication terminal receiving the data is not the final destination, the communication terminal searches communication terminals within its coverage area for the communication terminal corresponding to the final destination, and when the communication terminal corresponding to the final destination is found, transmits the data to the communication terminal corresponding to the final destination. Otherwise, the communication terminal transmits the received data to a communication terminal nearest to the communication terminal, which corresponds to the final destination, within the coverage area of the communication terminal that has received the data.

In step (a), the information on the communication terminals within the coverage area includes latitude and longitude information indicating a position of each communication terminal, and the communication terminal nearest to the communication terminal corresponding to the final destination is selected based on latitude and longitude information of the communication terminals within the coverage area and the latitude and longitude information indicating the position of the communication terminal corresponding to the final destination.

There is also provided a communication apparatus including a terminal coordinate manager storing position information of the communication terminal and receiving and storing position information of other communication terminals within a coverage area of the communication terminal, a reception data analyzer analyzing reception data to determine whether the communication terminal is a destination of the reception data and whether the communication terminal is a final destination of the reception data, and a relay transmitter transmitting the reception data to the final destination or another communication terminal nearest to the final destination among the communication terminals within the coverage area, when the reception data analyzer determines that the communication terminal is not the final destination.

### BRIEF DESCRIPTION OF THE DRAWINGS

FIG. 1 shows conventional data communication paths.

FIG. 2 shows data communication paths according to a preferred embodiment of the present invention.

FIG. 3A shows a data communication procedure performed by a communication terminal according to a preferred embodiment of the present invention.

FIG. 3B shows a communication terminal according to a preferred embodiment of the present invention.

FIG. 4 shows the packet structure of communication data according to a preferred embodiment of the present invention.

FIG. 5A shows a data relay procedure performed by a communication terminal according to a preferred embodiment of the present invention.

FIG. 5B shows a method of selecting a relay terminal in the data relay procedure performed by a communication terminal, according to a preferred embodiment of the present invention.

FIG. 6A shows a method of selecting a communication terminal as a local server according to a preferred embodiment of the present invention.

FIG. 6B shows a method of designating a server or temporary server according to a preferred embodiment of the present invention.

FIG. 7 shows the hardware structure and system information of a communication terminal according to a preferred embodiment of the present invention.

### BEST MODE FOR CARRYING OUT THE INVENTION

In general wireless communication, any types of terminals using the same frequency band within a coverage area can communicate with each other. However, if a terminal is out of the coverage area, a relay base station is required for communication. Here, for long-distance communication, it is convenient to use a relay base station. However, for short-distance communication, it will be convenient to use a terminal having a relay function without using a relay base station. Accordingly, the present invention adds bridge and router functions to a communication terminal and uses the communication terminal having the relay function for communication between communication terminals out of a coverage area.

Here, in order to select a communication terminal functioning as a relay from a plurality of communication terminals, a GPS function is added to communication terminals, and a communication terminal, which is determined as being nearest to a destination using coordinate values of positions of the communication terminals, is selected as a relay. If communication terminals not having the GPS function are used, a coordinate value of each communication terminal can be stored in a storage of a relay in advance. The coordinate value is used for the same function as a MAC address. MAC addresses are referred to as physical addresses and are allocated to individual ports, such as LAN cards, of a network apparatus in order to identify destinations when data is transmitted.

In other words, data is transmitted to a desired destination using a GPS coordinate value as a MAC address through the relay of an intermediate terminal. On the earth, a position can be identified using longitude and latitude, which are absolute values and do not change according to the conditions. In the present invention, each communication terminal stores a unique code and its longitude and latitude values. The longitude and latitude values can be automatically obtained using GPS reception data. Otherwise, these values can be manually input in a relay in advance.

In the present invention, packets can be used for data transmission. Each packet may include information on, for example, a destination and a source, in the header portion and may include commands for controlling various types of communication terminals and information collected from each communication terminal in the data portion.

In the present invention, each communication terminal is designed such that it can periodically transmit the self information, i.e., self position information including its unique code, longitude, and latitude, to other communication terminals within a coverage area for the purpose of enabling each communication terminal used in the present invention to store the position information of the other communication terminals within its coverage area. Accordingly, each of the communication terminals stores the position information of the other communication terminals within its coverage area in the form of a table.

The following description concerns a procedure in which a communication terminal relays data. A transmission terminal searches the position information of other communication terminals stored in its memory for the unique code or position information of a destination terminal. When information on the destination terminal is not found, the destination terminal does not exist within the coverage area of the transmission terminal. In this situation, the transmission terminal subtracts the longitude and latitude values of each communication terminal, whose position information is stored in the memory of the transmission terminal, from the longitude and latitude values of the destination terminal. Then, the transmission terminal selects a communication terminal, which has the least result of subtraction, as a relay terminal and transmits data to the selected communication terminal. However, if the selected communication terminal does not respond within a predetermined period of time, the transmission terminal transmits the data to a communication terminal having the second least result of subtraction.

The communication terminal selected as a relay terminal transmits a signal for confirming the reception of data to the transmission terminal and may discard the data when a time-to-live (TTL) value contained in the data is 0. Thereafter, the relay terminal selects a communication terminal nearest to the destination terminal from a list of communication terminals, which is stored within the relay terminal, and transmits the data to the selected communication terminal. Here, the relay terminal may subtract 1 from the TTL value contained in the data before transmitting the data in order to prevent the data from being transmitted infinitely.

In the present invention, a server, a local server, or a terminal may be set as a communication terminal. A server has general information of all wireless terminals. Furthermore, the server can transmit or receive data through the Internet with its own IP address. The server also can transmit or receive the general information to or from each terminal. Here, each terminal may basically include the unique code and position information (i.e., longitude and latitude) of the server. In addition, when each terminal does not know the position-information of a destination to finally receive data, the terminal can transmit the data to the destination through the server.

In the present invention, a coverage area is divided into a plurality of sections, and a terminal in the center of each section is defined as a local server. When collecting data through, for example, metering and transmitting the data to a server, the local server may primarily collect the data and transmit the collected data to the server. It is preferable that the local server can be remotely designated through the server.

In the present invention, a terminal has bridge and router functions, stores self position information (longitude and latitude), periodically transmits the self position information to the other terminals within its coverage area so that the other terminals share the self position information, receives position information from each of the other terminals within the coverage area, and stores the received position information. Such position information is used to relay data. All of the terminals can serve as a server, local server, or relay.

The term communication terminal used in this specification denotes a personal communication terminal, such as a cellular phone or a PDA phone, a measuring instrument, such as a water meter or electric meter, having various wireless communication functions, and other devices or machines, such as vehicles with a wireless calling apparatus, having functions of performing wireless calling and data transmission.

Hereinafter, preferred embodiments of the present invention will be described in detail with reference to the attached drawings.

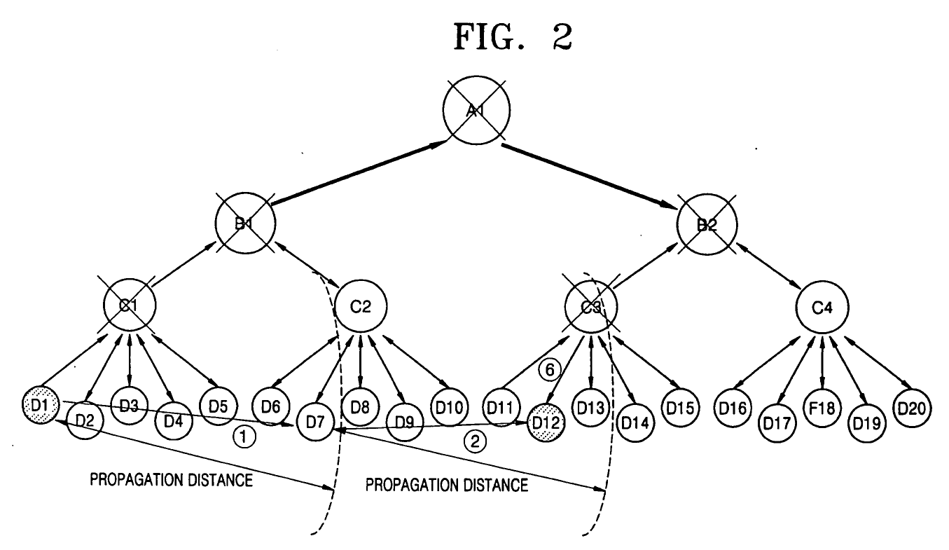

FIG. 2 shows data communication paths according to a preferred embodiment of the present invention. In FIG. 2, reference characters D1 through D20 denote communication terminals. Reference characters C1 through C4 denote primary communication relays.

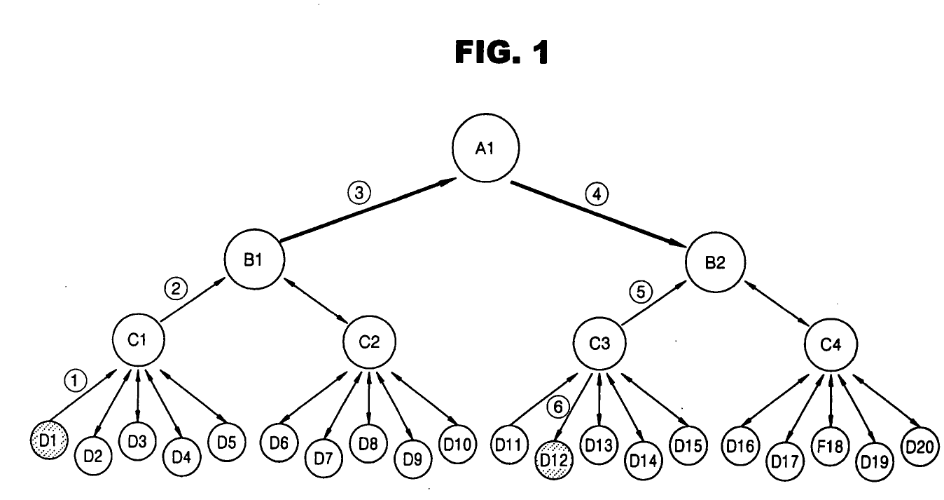

Reference characters B1 and B2 denote secondary communication relays. Reference character A1 denotes a tertiary communication relay. Unlike the data communication path shown in FIG. 1, data can be transmitted from the communication terminal D1 to the communication terminal D12 through a simple communication path \mathring{1}→\mathring{2}.

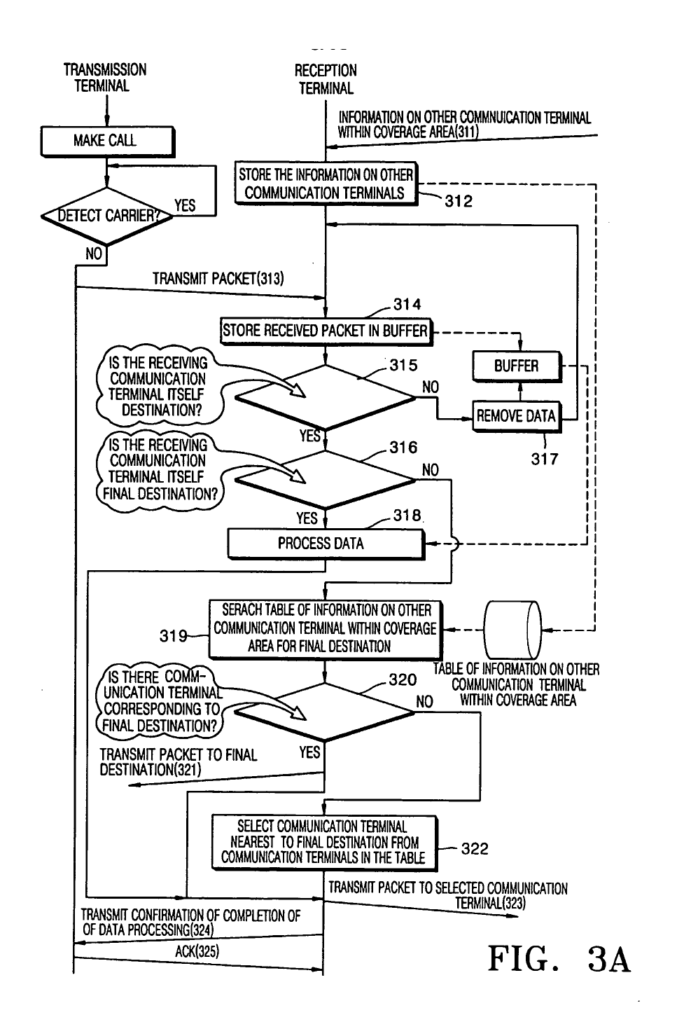

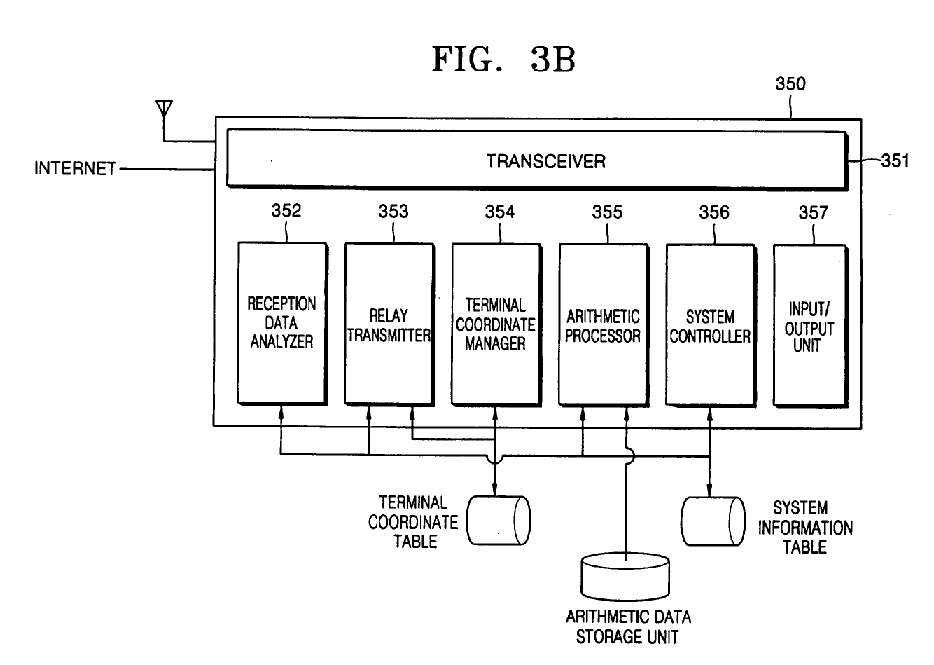

FIG. 3A shows a data communication procedure performed by a communication terminal according to a preferred embodiment of the present invention.

A reception terminal receives information on other communication terminals within a coverage area in step 311 and stores the information in a database in step 312. The information on the other communication terminals includes each terminal's unique code and position information containing longitude and latitude.

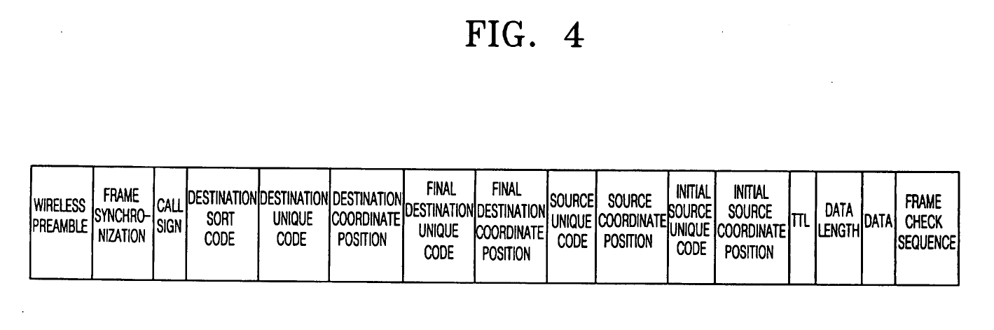

Thereafter, a transmission terminal makes data into a packet and is transmits the packet in step 313. A packet according to a preferred embodiment of the present invention is shown in FIG. 4. The reception terminal stores the received packet in a buffer in step 314 and analyzes the header data of the packet to determine whether the reception terminal itself is a destination of the data in step 315. If it is determined that the reception terminal itself is not the destination terminal, the reception terminal removes the received data from the buffer in step 317. If it is determined that the reception terminal itself is the destination terminal, the reception terminal analyzes the header data of the packet to determine whether the reception terminal itself is a final destination of the data in step 316. If it is determined that the reception terminal itself is the final destination, the reception terminal processes the data in step 318.

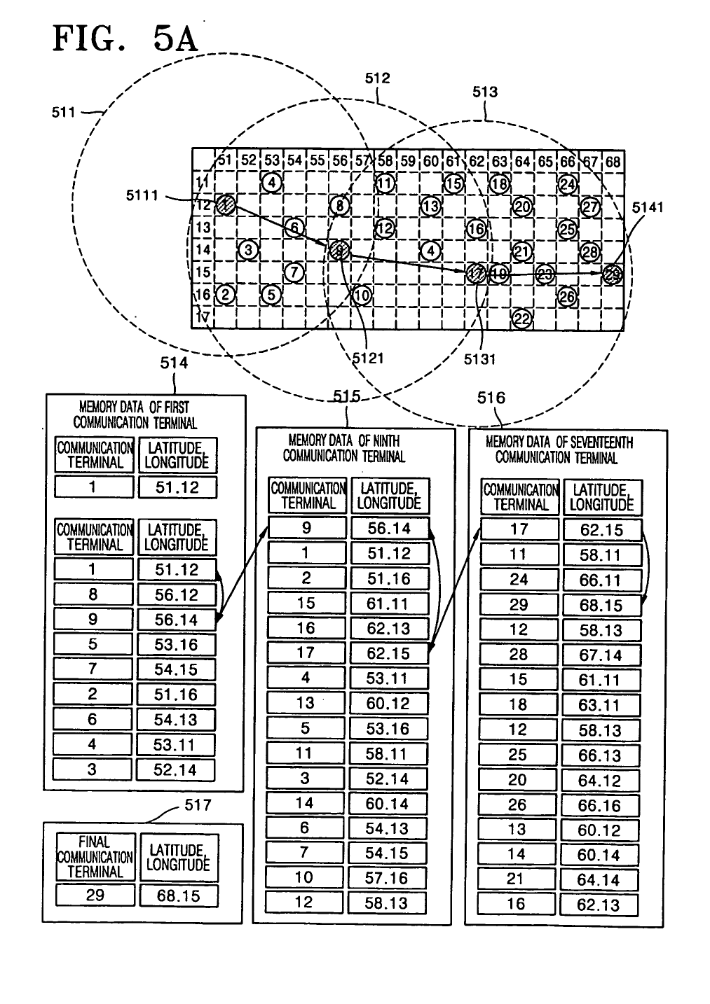

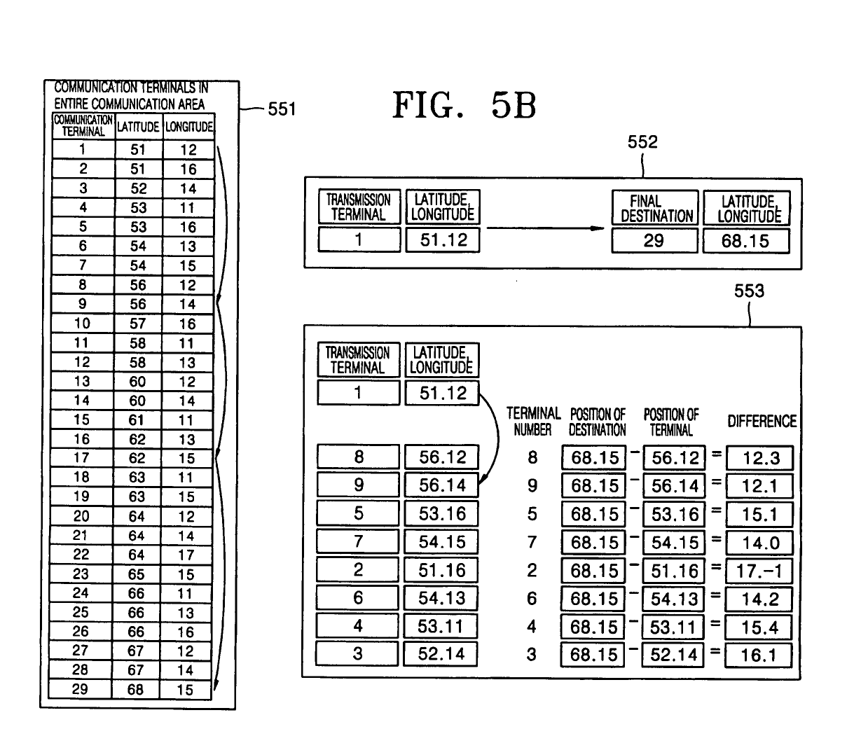

If it is determined that the reception terminal itself is not the final destination, the reception terminal searches the information on the other communication terminals within the coverage area, which was stored in step 312, in step 319 and determines whether the information includes a communication terminal corresponding to the final destination in step 320. If it is determined that the information includes a communication terminal corresponding to the final destination, the reception terminal transmits the data to the communication terminal corresponding to the final destination in step 321. If it is determined that the information does not include a communication terminal corresponding to the final destination, the reception terminal selects a communication terminal nearest to the final destination from the other communication terminals within the coverage area in step 322 and transmits the data to the selected communication terminal in step 323. Here, the communication terminal nearest to the final destination is selected from the other communication terminals within the coverage area based on the position information containing longitude and latitude of each communication terminal. A selection method according to a preferred embodiment of the present invention is shown in FIG. 5A. In the meantime, when the reception terminal processed the data in operation 318 or transmitted the data to another communication terminal in operation 321 or 323, it transmits confirmation of the completion of data processing to the transmitting communication terminal in operation 324 and receives an acknowledge (ACK) from the transmission terminal in operation 325.

FIG. 3B shows a communication terminal according to a preferred embodiment of the present invention.

A communication terminal 350 includes a transceiver 351, a reception data analyzer 352, a relay transmitter 353, a terminal coordinate manager 354, an arithmetic processor 355, a system controller 356, and an input/output unit 357.

The transceiver 351 transmits necessary information to or receives necessary information from other communication terminals and can be connected to the Internet.

The reception data analyzer 352 analyzes a header portion of packet data received through the transceiver 351, determines whether the communication terminal 350 corresponds to a destination of the s received data, and, if it is determined that the communication terminal 350 corresponds to the destination, determines whether the communication terminal 350 corresponds to a final destination of the received data.

The terminal coordinate manager 354 receives the unique code and position information containing longitude and latitude of each of the other communication terminals within a coverage area from the transceiver 351 and stores the unique code and position information.

When the reception data analyzer 352 determines that the communication terminal 350 corresponds to the destination of the received data but does not correspond to the final destination of the received data, the relay transmitter 353 searches a terminal coordinate table, which includes information on the other communication terminals within the coverage area, for a communication terminal corresponding to the final destination. If the communication terminal corresponding to the final destination is found, the relay transmitter 353 transmits the received data to the found communication terminal. Otherwise, the relay transmitter 353 selects a communication terminal nearest to the communication terminal corresponding to the final destination and transmits the received data to the selected communication terminal. Here, a communication terminal having the nearest longitude and latitude to the longitude and latitude of the communication terminal corresponding to the final destination is selected.

When the reception data analyzer 352 determines that the communication terminal 350 corresponds to the destination of the received data and also corresponds to the final destination of the received data, the arithmetic processor 355 processes the received data and then stores the data.

The input/output unit 357 receives data or the outputs of, for example, a sensor or outputs controls or data.

The system controller 356 controls the transceiver 351, the reception data analyzer 352, the relay transmitter 353, the terminal coordinate manager 354, the arithmetic processor 355, and the input/output unit 357 according to system information. The system information may contain the unique code of each communication terminal, the longitude and latitude of each communication terminal as position information, the motion or standstill of each communication terminal as state information, Internet connection state, information on the server connected to the communication terminal 350, TTL, and the IP address of the communication terminal 350. Here, the TTL is a is separate value from a TTL within an IP packet and is provided to prevent the packet from being infinitely relayed by communication terminals.

FIG. 4 shows the packet structure of communication data according to a preferred embodiment of the present invention. A wireless preamble is a signal which starts with 1, necessary to establish synchronization before data transmission and ends with 0. The wireless preamble has a fixed length, for example, of 56 bits. A call sign is a signal for identifying a communication terminal.

A destination sort code indicates whether a destination is a single terminal or a group of terminals. A destination unique code is information for designating a reception terminal. A destination position is information on the longitude and latitude of a position of the reception terminal. When the data is transmitted to a plurality of communication terminals, the destination coordinate position may be set to a null value. A final destination unique code indicates the unique code of a communication terminal corresponding to a final destination. If a group including a plurality of communication terminals is designated as the final destination, a group code allocated to the group of communication terminals may be used. A final destination position is position information containing the longitude and latitude of a communication terminal corresponding to the final destination. If a plurality of communication terminals are designated as the final destination, the final destination position may be set to a null value. An initial source unique code is the unique code of a communication terminal which initially transmits the data and indicates the origin of the data. An initial source position contains the longitude and latitude of the communication terminal which initially transmits the data. A TTL has been described above. A data length is information indicating the length of the data.

FIG. 5A shows a data relay procedure performed by a communication terminal according to a preferred embodiment of the is present invention. A first circle 511 indicates a coverage area of a first communication terminal 5111. A second circle 512 indicates a coverage area of a ninth communication terminal 5121. A third circle 513 indicates a coverage area of a seventeenth communication terminal 5131. Memory data 514 of the first communication terminal 5111 includes the unique code and position information of the first communication terminal 5111 and the unique code and position information of each of the other communication terminal within the coverage area of the first communication terminal 5111. The position information contains the longitude and latitude of each communication terminal. The first communication terminal 5111 compares the position information of other communication terminals included in the memory data 514 with the position information of a twenty-ninth communication terminal 5141 corresponding to a final destination, selects the ninth terminal 5121 nearest to the final communication terminal 5141 based on the position information of the other communication terminals included in the memory data 514, and transmits data to the ninth communication terminal 5121.

Memory data 515 of the ninth communication terminal 5121 includes the position information of the ninth communication terminal 5121 and the position information of each of the other communication terminal within the coverage area of the ninth communication terminal 5121. The position information contains the longitude and latitude of each communication terminal. The ninth communication terminal 5121 compares the position information of other communication terminals included in the memory data 515 with the position information of the twenty-ninth communication terminal 5141 corresponding to the final destination, selects the seventeenth terminal 5131 nearest to the final communication terminal 5141 based on the position information of the other communication terminals included in the memory data 515, and transmits data to the seventeenth communication terminal 5131.

Memory data 516 of the seventeenth communication terminal 5131 includes the position information of the seventeenth communication terminal 5131 and the position information of each of the other communication terminal within the coverage area of the seventeenth communication terminal 5131. The position information contains the longitude and latitude of each communication terminal. The seventeenth communication terminal 5131 confirms that it is not the final destination of the data and searches the memory data 516 for a communication terminal corresponding to the final destination. As the result of searching, the seventeenth communication terminal 5131 finds that it has information on the twenty-ninth communication terminal 5141 corresponding to the final destination and transmits the data to the twenty-ninth communication terminal 5141. Reference numeral 517 denotes the position information of the twenty-ninth communication terminal 5141 stored in a memory of the twenty-ninth communication terminal 5141.

FIG. 5B shows a method of selecting a relay terminal in the data relay procedure performed by a communication terminal, as shown in FIG. 5A, according to a preferred embodiment of the present invention.

Reference numeral 551 denotes a table including the unique code, latitude, and longitude of each of the communication terminals included in the entire communication area shown in FIG. 5A. The arrows on the right side in the table 551 denote that data is transmitted from the first communication terminal 5111 to the ninth communication terminal 5121, then from the ninth communication terminal 5121 to the seventeenth communication terminal 5131, and then from the seventeenth communication terminal 5131 to the twenty-ninth communication terminal 5141.

Reference numeral 552 shows the unique code, latitude, and longitude of the first communication terminal 5111, which initially transmits the data, and the unique code, latitude, and longitude of the twenty-ninth communication terminal 5141 corresponding to the final destination.

Reference numeral 553 shows a procedure for selecting the ninth communication terminal 5121 as a communication terminal to which the first communication terminal 5111 transmits the data. First, a difference between the latitude and longitude of the twenty-ninth communication terminal 5141 corresponding to the final destination and the latitude and longitude of each of the other communication terminals within the coverage area of the first communication terminal 5111, which are stored in the memory of the first communication terminal 5111, is obtained. Differences obtained for the respective other communication terminals are compared with one another, and a communication terminal having the least difference is selected as a communication terminal to which the first communication terminal 5111 transmits the data. Referring to FIG. 5B, the eighth communication terminal has a difference (12, 3); the ninth communication terminal has a difference (12, 1); the fifth communication terminal has a difference (15, 1); the seventh communication terminal has a difference (14, 0); the second communication terminal has a difference (17, −1); the sixth communication terminal has a difference (14, 2); the fourth communication terminal has a difference (15, 4); and the third communication terminal has a difference (16, 1). Accordingly, the ninth communication terminal 4121 has the least difference. Here, (12, 3) indicating the latitude and longitude with respect to the eighth communication terminal is just an exemplary value.

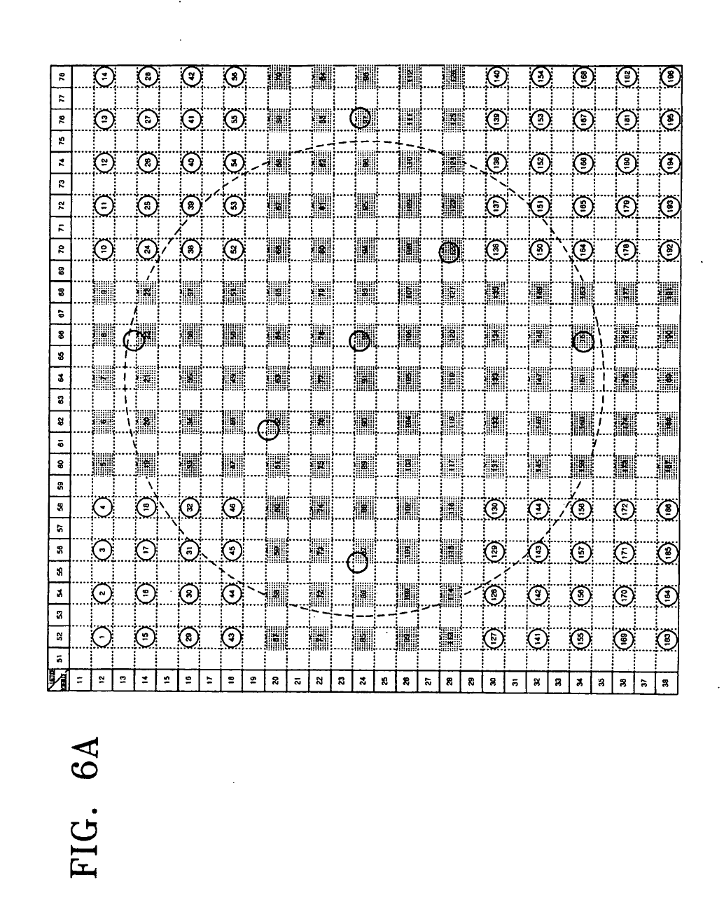

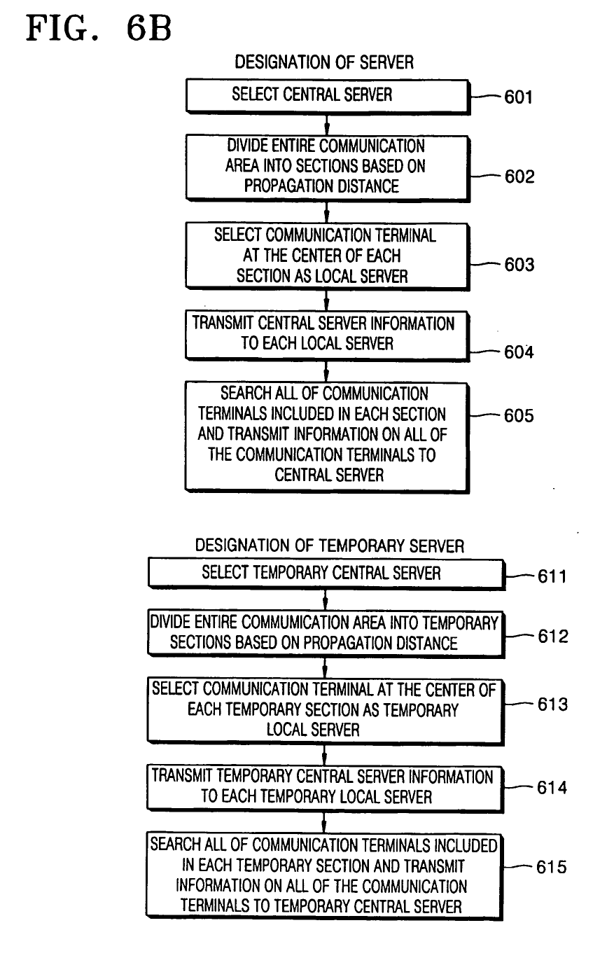

FIG. 6A shows a method of selecting a communication terminal as a local server according to a preferred embodiment of the present invention. When the radius of the coverage area of a communication terminal is 500 M, communication terminals at a distance of 500 M from a reference terminal in upward, downward, leftward, and rightward directions can be selected as local servers. For example, when a terminal 91 is a reference terminal, terminals 21, 86, 96, and 161 can be selected as local servers. Here, communication terminals 66 through 84, 94, 95, 97, 98, 108 through 112, and 122 through 126 belong to the communication terminal 96 selected as the local server.

FIG. 6B shows a method of designating a server or temporary server according to a preferred embodiment of the present invention. A central server is first selected in step 601. An entire communication area is divided into sections based on propagation distance in step 602. A communication terminal at the center of each section is selected as a local server in step 603. Central server information is transmitted to each local server, and simultaneously, information on the selected local servers is transmitted to the central server in step 604. Each local server searches all of the communication terminals included in the section of the local server, and information on the communication terminals is transmitted to the central server in operation 605.

A temporary central server is first selected in step 611. An entire communication area is divided into temporary sections based on propagation distance in step 612. A communication terminal at the s center of each temporary section is selected as a temporary local server in step 613. Temporary central server information is transmitted to each temporary local server, and simultaneously, information on the selected temporary local servers is transmitted to the temporary central server in step 614. Each temporary local server searches all of the communication terminals included in the temporary section of the temporary local server, and information on the communication terminals is transmitted to the temporary central server in step 615.

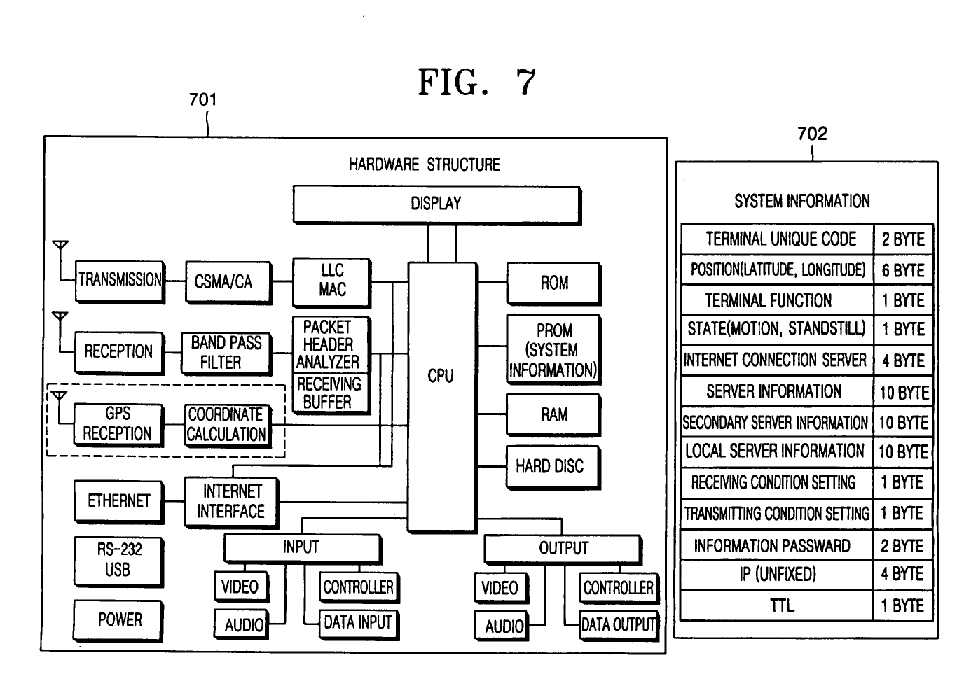

FIG. 7 shows the hardware structure of a communication terminal and system information according to a preferred embodiment of the present invention. Reference numeral 701 denotes a hardware structure of a communication terminal. Reference numeral 702 denotes system information stored in a PROM of the hardware structure 701. In the hardware structure 701, a carrier sense multiple access/collision avoidance (CSMA/CA) is a modification of a CSMA/CD (collision detection) and is used together with LocalTalk of the Apple or other wireless access methods. Each communication terminal always monitors carrier waves over networks and when the networks are empty, send data after waiting for a period of time, which is determined in accordance with their positions registered in a list. Various kinds of methods can be used to set the priority among the terminals in the list and reset the priority. In some versions, collision may occur. When collision occurs, a collision detecting process is performed. In addition, media access control (MAC) and logical link control (LLC) are two layers constituting a data link layer in the IEEE 802 LAN standards. A global positioning system (GPS) is a system for identifying and determining positions using satellites and provides position and time information. 24 GPS satellites (actually, 27 GPS satellites including three supplementary satellites) circle the earth in different orbits in the atmosphere so that four or more satellite signals can be obtained at any time and any place on the earth. To detect a position, signals must be simultaneously received from at least four satellites. GPS receivers are divided into 4 channel receivers and 8 channel receivers depending on the number of satellite signals which can be simultaneously processed. The GPS and a geographical information system (GIS) are usually used in a navigation system for planes, ships, and vehicles and also used to detect the position of a moving object such as persons or vehicles. A universal serial bus (USB) is a kind of serial port which started to arouse peoples' interest when Windows 98 was launched, and is a plug-and-play interface between a computer and a peripheral device such as an audio player, joystick, keyboard, telephone, scanner, or printer. The principle of the USB is the same as that of the serial port, but is faster and easier to connect than the serial port. Since the USB supports a data transmission rate of 12 Mbps, a satisfactory speed can be obtained when usual peripheral devices are connected. The USB allows a maximum of 127 devices to be connected as if in chains. In addition, even if a device is connected in the middle of use of a PC, the device is recognized, and separate power supply for the peripheral devices is not necessary. Generally, a PC has two USB ports, but also has a USB hub, so a variety of peripheral devices can be connected to a single USB port.

In the system information 702, a terminal unique code can be uniquely allocated to a terminal according to the usage and specifications of the terminal in order to discriminate the terminal from other terminals (basically, the terminal unique code can be set to be the same as an Ethernet hard number) and is information having a size of 2 bytes.

When a terminal uses a GPS receiving board, position (latitude, longitude) information is automatically detected and input by the GPS receiving board. However, when a wireless terminal is used only in a standstill state, the GPS receiving board is not necessary. In this case, the position information may be manually input. Terminal function information designates a terminal's function, such as control, input, or output, of a server, local server, Internet connection server, data collection terminal, data relay terminal, peripheral terminal, or predetermined connected device. Internet connection server information is information on an Internet connection terminal (for example, unique code and position coordinates of the terminal). Server information contains the unique code and position information of a server. Local server information contains the unique number and position data of a local server. A terminal periodically transmits the self information to a server, and a local server periodically transmits information on all of the terminals within a local area corresponding to the local server to the server. Receiving condition setting information contains the unique code and group code of the current terminal to filter the received data. Transmitting condition setting information is provided to designate a particular terminal or a particular terminal group as a destination when data is initially transmitted. An information password is required to change data which has been set in the terminal. An IP address may be set in the terminal, which is connected to the Internet. The above-described information may be stored in a PROM so that the information cannot be deleted.

When a temporary server is designated, temporary system information can be temporarily stored in a RAM in order to make a particular wireless terminal to temporarily perform an extra function other than an initially set function. After the extra function is completed or after a predetermined period of time lapses, the temporary system information stored in the RAM may be deleted so that the terminal can perform the function according to original system information stored in the PROM. Temporary system information may contain the function of a temporary terminal, information on a temporary server, information on a temporary local server, temporary receiving condition setting information, and temporary password, etc. TTL is provided to prevent packet data from being infinitely relayed among wireless terminals.

The present invention can be embodied as a program which can be executed in a computer. The program can be read from a medium used in a computer and executed by the computer. The medium may be a storage medium, such as a magnetic storage medium (for example, a ROM, a floppy disc, or a hard disc), an optical readable medium (for example, a CD-ROM or a DVD), or a carrier wave (for example, transmission through the Internet).

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

### Industrial Applicability

According to the present invention, data can be transmitted from one communication terminal to another communication terminal, out of the coverage area of the one communication terminal, using communication terminals as relays, so it is not necessary to establish an extra base station, thereby providing an economical and convenient communication method and apparatus. In addition, even if one of the communication terminals is broken, the data can be transmitted via another communication terminal. Since one of a plurality of communication terminals can be designated as a server to collect data and transmit necessary data to each communication terminal, remote control can be accomplished.

Moreover, when there are many communication terminals (for example, water meters or electric meters) in a narrow area, data collection and remote control can be accomplished without setting telephone numbers or IP addresses. When a particular communication terminal is designated as a server and connected to the Internet, data can be collected through the Internet or transmitted to each communication terminal.

What is claimed is:

1. A wireless communication method comprising the steps of:
(a) each communication terminal within a coverage area receiving and storing information on other communication terminals within the coverage area;
(b) one communication terminal among the communication terminals within the coverage area receiving and storing data from another communication terminal among the communication terminals within the coverage area;
(c) the communication terminal receiving the data analyzing the received data to determine whether the communication terminal is a destination of the received data and a final destination of the received data; and
(d) when the communication terminal is determined as the destination but not the final destination, the communication terminal transmitting the data to another communication terminal nearest to a communication terminal, which corresponds to the final destination, within a coverage area of the communication terminal that has received the data.

2. A computer readable recording medium on which a program for executing the wireless communication method of claim 1 in a computer is recorded.

3. The wireless communication method of claim 1, wherein in step (d), the communication terminal receiving the data searches communication terminals within its coverage area for the communication terminal corresponding to the final destination and when the communication terminal corresponding to the final destination is found, transmits the data to the communication terminal corresponding to the final destination.

4. A computer readable recording medium on which a program for executing the wireless communication method of claim 3 in a computer is recorded.

5. The wireless communication method of claim 3, wherein in step (a), the information on the communication terminals within the coverage area comprises latitude and longitude information indicating a position of each communication terminal, in step (b), the received data comprises latitude and longitude information indicating a position of the communication terminal receiving the data and latitude and longitude information indicating a position of the communication terminal corresponding to the final destination, and
the communication terminal nearest to the communication terminal corresponding to the final destination is selected based on latitude and longitude information of the communication terminals within the coverage area and the latitude and longitude information indicating the position of the communication terminal corresponding to the final destination.

6. A computer readable recording medium on which a program for executing the wireless communication method of claim in a computer is recorded.

7. A wireless communication apparatus, comprising:
a communication unit receiving data from external communication devices and transmitting data to the external communication devices;
a coordinate management unit storing position information of the wireless communication apparatus and the external communication devices within a coverage area of the wireless communication apparatus;
a data analyzing unit analyzing reception data to determine whether the wireless communication apparatus is a destination of the reception data and is a final destination of the reception data; and
a relay unit transmitting the reception data to the final destination or another communication device nearest to the final destination among the communication devices within the coverage area when the data analyzing unit determines that the wireless communication apparatus is not the final destination.

8. A wireless communication apparatus comprising:
a communication unit receiving data from external communication devices and transmitting data to the external communication devices;
a first storing unit storing system information which includes function information and position information of the wireless communication apparatus;
a second storing unit storing position information of the external communication devices within a coverage area of the wireless communication apparatus;
a coordinate management unit storing position information of the wireless communication apparatus and the external communication devices within a coverage area of the wireless communication apparatus;
a data analyzing unit analyzing reception data to determine whether the wireless communication apparatus is a destination of the reception data and is a final destination of the reception data; and
a relay unit transmitting the reception data to the final destination or another communication device nearest to the final destination among the communication devices within the coverage area when the data analyzing unit determines that the wireless communication apparatus is not the final destination,
wherein the wireless communication apparatus acts as one among a first server which contains position information of each communication device and endows function of each communication device, a second server which collects information of other communication devices within a coverage area of the second server, and a communication terminal which transmits its unique code and position information, according to the function defined by the function information.

9. A communication packet structure comprising:
a destination sort code portion indicating a sort of destination as a single terminal or a group of terminals;
a destination position portion containing a unique code, latitude, and longitude of a destination terminal;
a final destination position portion containing a unique code, latitude, and longitude of a final destination terminal; and
a data portion containing information to be transmitted to the final destination terminal.
